(19) United States
(12) Patent Application Publication
(10) Pub. No.: US 2023/0283539 A1
(43) Pub. Date: Sep. 7, 2023

(54) PERFORMANCE MONITORING DEVICE, PROGRAM AND PERFORMANCE MONITORING METHOD

(71) Applicant: Nippon Telegraph and Telephone Corporation, Tokyo (JP)

(72) Inventors: Takayoshi HIRASAWA, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 18/013,449

(22) PCT Filed: Jun. 30, 2020
(86) PCT No.: PCT/JP2020/025656

§ 371 Date: Dec. 28, 2022

(51) Int. Cl. H04L 43/20; H04L 43/0852

(52) U.S. Cl. CPC H04L 43/20; H04L 43/0852

(57) ABSTRACT

A performance monitoring device enables performance monitoring by transfer delay monitoring of a virtual server that operates on a physical server including a physical resource and provides a network function. A performance monitoring device includes: a deployment unit that causes, in a case where the number of the virtual server is one, a measurement virtual server using the same physical resource as the physical resource of the virtual server to operate on the physical server; a path setting unit that sets the measurement virtual server to transmit a response packet to the performance monitoring device for a measurement packet; and a measurement unit that measures a first transfer time from when the measurement packet is transmitted to the measurement virtual server until the response packet is received.

### TECHNICAL FIELD

The present invention relates to a performance monitoring device, a program, and a performance monitoring method for monitoring performance of a virtual server that provides a network service using a virtualization technology.

### BACKGROUND ART

A network device such as a router or a switch, and a security device such as a firewall or an Intrusion Prevention System/Intrusion Detection System (IPS/IDS) are generally in the form of an appliance (dedicated hardware). There is a problem that the appliance occupies space and cannot change processing capability. On the other hand, network functions virtualization (NFV) has been studied in which functions of a network device and a security device are achieved not by an appliance but by a virtual server (virtualization server) on a general-purpose server (physical server, server). In particular, in a next-generation network such as 5G, a virtualized network function (VNF) component created on the premise that a network function is provided by a virtual server has been developed.

On the other hand, in a network such as 5G, there is also a requirement regarding a transfer delay of the network, and there is an increasing need to satisfy the requirement of the transfer delay even when a network function is configured using a VNF. A transfer delay occurs in a network and a server that implements a service. Non Patent Literature 1 proposes a measurement technology that enables specification of a location and a direction of a delay, and a delay amount by utilizing a protocol capable of flexible path control such as segment routing (SR).

### CITATION LIST

### Non Patent Literature

Non Patent Literature 1: Takayoshi Hirasawa et al., “Study on technology of estimating occurrence position and direction of delay in network” 2020 IEICE General Conference, B-6-63, March 2020

### SUMMARY OF INVENTION

### Technical Problem

By using the measurement technique proposed in Non Patent Literature 1, it is possible to measure a transfer delay time in a network including a switch fabric in a data center, and it is possible to specify a location and a direction of a delay and a delay amount (delay time). However, it is not possible to measure or identify the cause of a delay occurring in a server.

In general, as delay measurement (delay monitoring, performance measurement, performance monitoring) in a virtual server, physical resources such as a central processing unit (CPU) and a memory included in a physical server are monitored, and transfer performance monitoring for monitoring (measuring) a network delay is not currently available. In particular, in a case of a service passing through a plurality of network functions (virtual servers) such as a service chain, a highly accurate delay monitoring method and resource allocation are required in order to maintain constant transfer performance as a chain, and a technology for measuring delay amounts of a plurality of chains for each user is required.

The present invention has been made in view of such a background, and an object thereof is to enable performance monitoring by transfer delay monitoring of a virtual server.

### Solution to Problem

In order to solve the above problem, a performance monitoring device according to the present invention is a performance monitoring device for a virtual server that operates on a physical server including a physical resource and provides a network function, the performance monitoring device including: a deployment unit that causes, in a case where the number of the virtual server is one, a measurement virtual server using the same physical resource as the physical resource of the virtual server to operate on the physical server; a path setting unit that sets the measurement virtual server to transmit a response packet to the performance monitoring device for a measurement packet; and a measurement unit that measures a first transfer time from when the measurement packet is transmitted to the measurement virtual server until the response packet is received.

### Advantageous Effects of Invention

According to the present invention, it is possible to enable performance monitoring by transfer delay monitoring of a virtual server.

### BRIEF DESCRIPTION OF DRAWINGS

FIG. 1 is an overall configuration diagram of a network that provides a network service to be monitored by a performance monitoring device according to the present embodiment.

FIG. 2 is a functional configuration diagram of the performance monitoring device according to the present embodiment.

FIG. 3 is a diagram for explaining a relationship related to deployment of a virtual server and a measurement virtual server deployed in a server according to the present embodiment.

FIG. 4 is a diagram for explaining a path of a measurement packet in a case where a plurality of virtual servers is chained to provide a network service according to the present embodiment.

FIG. 5 is a sequence diagram of performance monitoring processing according to the present embodiment.

FIG. 6 is a sequence diagram of migration processing according to the present embodiment.

FIG. 7 is a diagram for explaining a relationship related to deployment of virtual servers and a measurement virtual server deployed in a server according to a modification of the present embodiment.

FIG. 8 is a hardware configuration diagram illustrating an example of a computer that implements functions of the performance monitoring device according to the present embodiment.

### DESCRIPTION OF EMBODIMENTS

Hereinafter, a performance monitoring device in a mode (embodiment) for carrying out the present invention will be described. In the performance monitoring device, a virtual server (measurement virtual server, measurement VNF) for measurement that uses the same resource (CPU or memory) as a resource of a virtual server (VNF) that provides a network function to be monitored. Subsequently, the performance monitoring device measures and monitors the performance by measuring a time (transfer time, transfer delay time, first transfer time) during which the measurement virtual server transfers a measurement packet.

When the network service is implemented by a plurality of virtual servers sequentially processing (chaining) data, in the performance monitoring device, measurement virtual servers corresponding to the respective virtual servers are deployed. Next, the performance monitoring device sets the plurality of measurement virtual servers such that the corresponding measurement virtual servers transfer the measurement packets in the order similar to the order of the virtual servers that sequentially process (chain) the data. The last measurement virtual server of the chain is set to transfer the measurement packet to the performance monitoring device. Subsequently, the performance monitoring device measures and monitors the performance by transmitting a measurement packet to the first measurement virtual server of the chain and measuring a time (transfer time, transfer delay time, second transfer time) during which the measurement packet returns from the last measurement virtual server of the chain. In a case where there is a problem in performance, the first transfer time is measured for each of the plurality of measurement virtual servers, and a virtual server having a problem is specified.

When there is a virtual server (performance degraded virtual server) having a performance problem, the performance monitoring device moves the virtual server to another physical server or to use another resource. When a plurality of virtual servers is chained to provide a network service, a virtual server having a problem is specified and moved. At this time, a path of the chained virtual server is also changed.

By monitoring the performance of the network function (VNF, virtual server, network service) using such a performance monitoring device, it is possible to monitor the performance with higher accuracy as compared with the case of monitoring the performance by monitoring the use state of the CPU or the memory as in the related art. By combining with the technology of measuring a transfer delay time in a network and the technology of specifying a location and a direction of the delay and a delay amount as disclosed in Non Patent Literature 1, it is possible to monitor a transfer delay in a communication path/resource similar to a user traffic consistently with a server and a switch. In addition, it is possible to configure a data center network maintaining a constant transfer delay time. By using the present technology, it is possible to provide a service with the transfer delay time as one index (a numerical value indicating service quality).

<<Overall Configuration>>

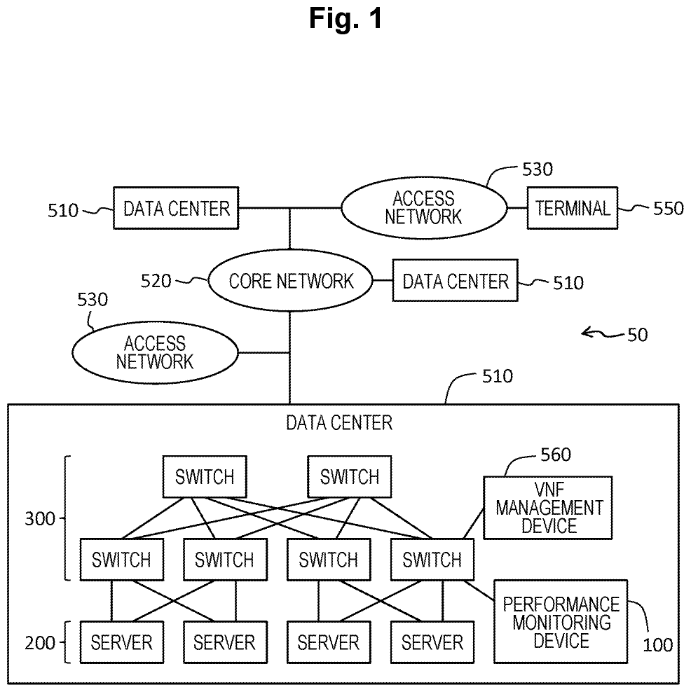

FIG. 1 is an overall configuration diagram of a network 50 that provides a network service to be monitored by a performance monitoring device 100 according to the present embodiment. The network 50 includes a core network 520, an access network 530, and a data center 510. A terminal 550 used by a user and a user base (user site, not illustrated) are connected to the access network 530. The data center 510 includes a server 200 (physical server) that provides a network service, and a switch 300 that connects the server 200 to the core network 520 and the access network 530. In the server 200, a virtual server (VNF) that provides a network service (network function) is deployed and operates. The number of virtual servers that provide the network service is not limited to one, and a plurality of virtual servers may sequentially process data (chain) to provide the network service.

The data center 510 further includes a virtual server management device 560 (described as a VNF management device in FIG. 1) and the performance monitoring device 100. The virtual server is managed by the virtual server management device 560. The virtual server management device 560 may be regarded as, for example, management and orchestration (MANO) in the NFV.

<<Configuration of Performance Monitoring Device>>

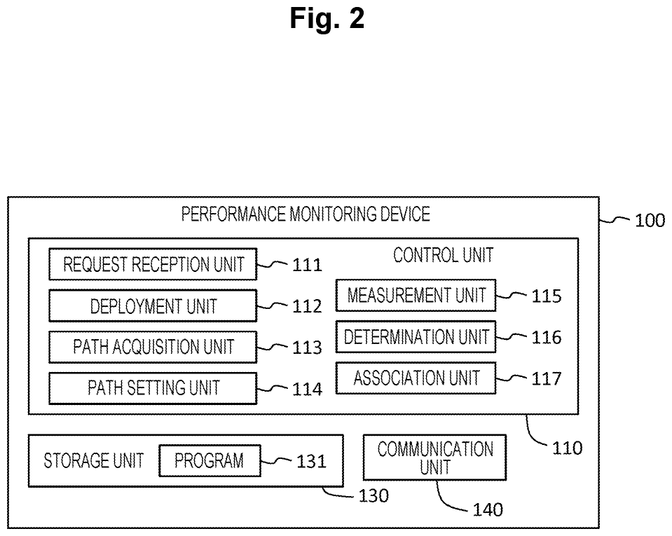

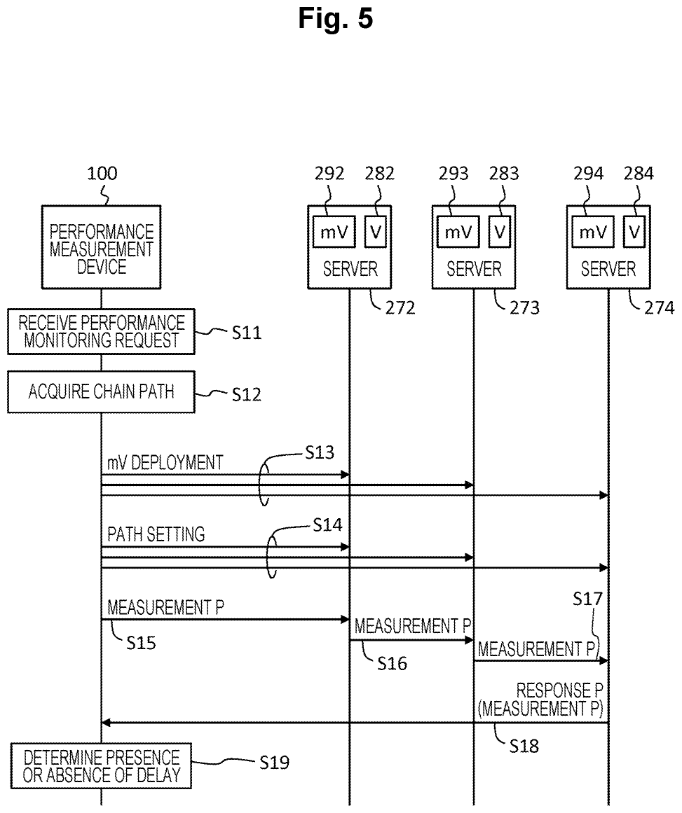

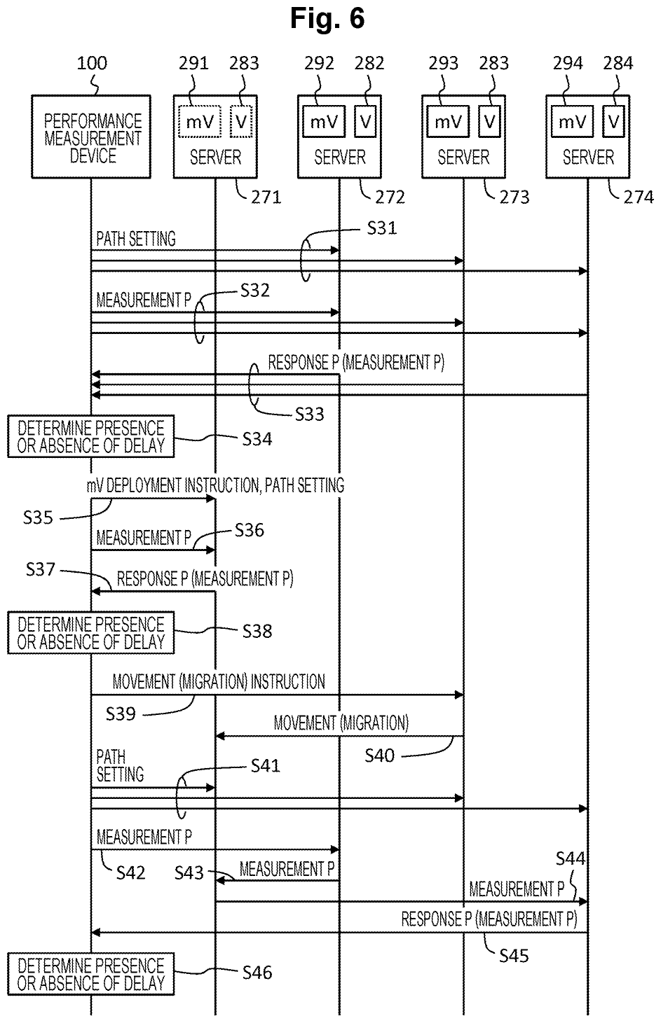

FIG. 2 is a functional configuration diagram of the performance monitoring device 100 according to the present embodiment. The performance monitoring device 100 includes a control unit 110, a storage unit 130, and a communication unit 140. The communication unit 140 transmits and receives communication data to and from devices such as the server 200 and the virtual server management device 560. The storage unit 130 includes a storage device such as a read only memory (ROM), a random access memory (RAM), or a solid state drive (SSD). In addition to a program 131 including processing procedures of performance monitoring processing (see FIG. 5 to be described later) and migration processing (see FIG. 6 to be described later), data necessary for these pieces of processing is stored in the storage unit 130.

The control unit 110 includes a CPU, and includes a request reception unit 111, a deployment unit 112, a path acquisition unit 113, a path setting unit 114, a measurement unit 115, a determination unit 116, and an association unit 117.

The request reception unit 111 receives a performance monitoring request including a network service whose performance is to be monitored. The request reception unit 111 receives a performance monitoring request from the virtual server management device 560, for example. The performance monitoring request may include information related to a virtual server that provides a network service and the server 200 on which the virtual server operates. The request reception unit 111 may acquire information related to the virtual server or the server 200 from the virtual server management device 560.

The deployment unit 112 deploys the measurement virtual server to the server 200. Specifically, the deployment unit 112 deploys the measurement virtual server such that the resource (physical resource, CPU, or memory) used by the virtual server to be monitored is also used by the measurement virtual server.

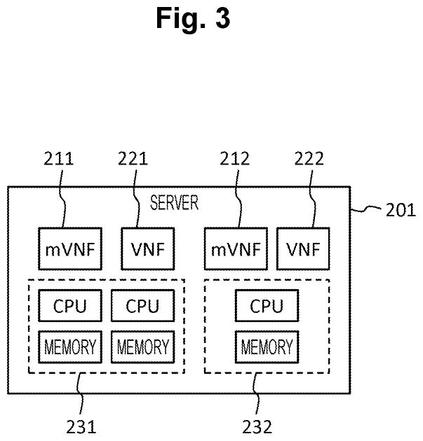

FIG. 3 is a diagram for explaining a relationship related to deployment of virtual servers 221, 222 (described as a VNF in FIG. 3) and measurement virtual servers 211, 212 (described as mVNF in FIG. 3) deployed in a server 201 according to the present embodiment.

The virtual server 221 operating in the server 201 uses a resource 231 including a CPU and a memory. The measurement virtual server 211 for the virtual server 221 is deployed to use the same resource 231 as the resource of the virtual server 221. The measurement virtual server 212 for the virtual server 222 operating in the same server 201 is deployed to use the same resource 232 as the resource of the virtual server 222.

The deployment unit 112 may request the virtual server management device 560 to deploy the measurement virtual server, or may directly request the server 200 to deploy the measurement virtual server. In a case where a plurality of virtual servers is chained, the deployment unit 112 deploys a measurement virtual server using the same resource for each virtual server. A case where a plurality of virtual servers uses the same resource will be described later as a modification.

Returning to FIG. 2, when the network service includes a plurality of virtual servers and the plurality of virtual servers sequentially processes (chains) data to provide the network service, the path acquisition unit 113 acquires the order (path) of the servers to be sequentially processed. The path acquisition unit 113 may acquire the path from the virtual server management device 560, or may acquire the path when the performance monitoring request includes the path.

The path setting unit 114 sets a path for transferring the measurement packet to the measurement virtual server. Specifically, when the number of virtual servers is one, the path setting unit 114 sets the measurement virtual server corresponding to the virtual server to transmit the received measurement packet to the performance monitoring device 100 as a response packet. When a plurality of virtual servers is chained, the path setting unit 114 sets the measurement virtual server corresponding to each virtual server (using the same resource) to transfer the measurement packet along the chained path (chain path).

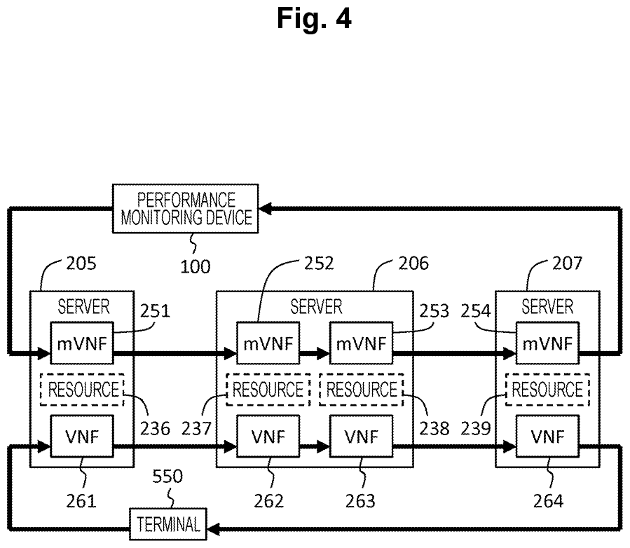

FIG. 4 is a diagram for explaining a path of a measurement packet in a case where a plurality of virtual servers 261 to 264 is chained to provide a network service according to the present embodiment. When a network service is requested from the terminal 550, the virtual servers 261 to 264 sequentially process (chain) and return a response to the terminal 550. In such a case, the deployment unit 112 deploys the measurement virtual servers 251 to 254 so as to use the same resources 236 to 239 as the resource 236 to 239 used by the virtual servers 261 to 264. The path (order of chains) acquired by the path acquisition unit 113 is the virtual server 261, the virtual server 262, the virtual server 263, and the virtual server 264. The path setting unit 114 sets the measurement virtual servers 251 to 254 so that the measurement packet is transferred in the order of the measurement virtual server 251, the measurement virtual server 252, the measurement virtual server 253, and the measurement virtual server 254. For example, the path setting unit 114 sets the measurement virtual server 252 to transfer the measurement packet received from the measurement virtual server 251 to the measurement virtual server 253.

In the description below, the path of the chain of the virtual servers 261 to 264 and the path in which the measurement packet of the measurement virtual servers 251 to 254 is transferred may be described as being the same.

For example, it may be described that the path of the measurement virtual servers 251 to 254 is set so as to be the same path as the virtual servers 261 to 264. For the path of the chain and the path in which the measurement packet is transferred, the virtualized servers in which the paths pass through are different, that is, the virtual server and the measurement virtual server, but the virtual server and the measurement virtual server use the same resource.

Returning to FIG. 2, the measurement unit 115 measures the transfer time (transfer delay time) of the network service by measuring the time from the transmission of the measurement packet to the measurement virtual server to the reception of the returned response packet. When the number of virtual servers is one, the time is the round time (first transfer time) of the measurement packet between the measurement virtual server corresponding to the virtual server and the performance monitoring device 100.

When the number of virtual servers is plural, the measurement unit 115 measures the time (second transfer time) taken for the measurement packet to be transmitted from the performance monitoring device 100 to the first measurement virtual server on the path, sequentially transferred along the path, and returned from the last measurement virtual server to the performance monitoring device 100. In the example of FIG. 4, a measurement packet (response packet) is transferred along a thick arrow that is transmitted from the performance monitoring device 100, pass through the measurement virtual servers 251 to 254, and returns to the performance monitoring device 100.

The determination unit 116 determines whether or not the transfer time is within a predetermined transfer time. The predetermined transfer time may be acquired from the virtual server management device 560. Alternatively, when included in the performance monitoring request, the time may be used for the predetermined transfer time. When the transfer time of the measurement packet exceeds a predetermined transfer time, it is described that performance degradation occurs in the network service or the virtual server. When the number of virtual servers is one and the transfer time (first transfer time) of the measurement packet exceeds a predetermined transfer time, the virtual server is also described as a performance degraded virtual server.

When the network service is provided in a chain of a plurality of virtual servers, when the transfer time (second transfer time) is not within the predetermined transfer time of the network service (the plurality of virtual servers), the determination unit 116 instructs the path setting unit 114 and the measurement unit 115 to measure the round transfer time (first transfer time) with each measurement virtual server. Next, the determination unit 116 compares each transfer time (first transfer time) with a predetermined transfer time related to each virtual server, and specifies a performance degraded virtual server in which the transfer time (first transfer time) exceeds the predetermined transfer time.

The association unit 117 moves (migrates) the performance degraded virtual server to the server 200 different from the server currently in operation or to use a resource different from the resource currently used. When the performance degraded virtual server is a chained virtual server, the chain path of the virtual server after the movement is maintained to be similar to that before the movement. This movement of the virtual server may be performed by instructing the virtual server management device 560.

<<Performance Measurement Processing>>

FIG. 5 is a sequence diagram of performance monitoring processing according to the present embodiment. Processing in which the performance monitoring device 100 measures and monitors the performance (transfer time) of the network service provided in a chain by the virtual server 282 to 284 (described as V in FIG. 5) will be described with reference to FIG. 5.

In step S11, the request reception unit 111 receives the performance measurement request. It is assumed that the performance measurement request includes information on the virtual servers 282 to 284 and the servers 272 to 274 for operation.

In step S12, the path acquisition unit 113 acquires the chain path of the virtual servers 282 to 284. Here, the path is the order of the virtual server 282, the virtual server 283, and the virtual server 284.

In step S13, the deployment unit 112 deploys measurement virtual servers 292 to 294 (described as mV in FIG. 5) corresponding to the virtual servers 282 to 284. Specifically, the measurement virtual servers 292 to 294 are deployed so as to use the same resource as the resource used by the virtual servers 282 to 284.

In step S14, the path setting unit 114 sets the measurement virtual servers 292 to 294 such that the transfer path of the measurement packet is the measurement virtual server 292, the measurement virtual server 293, and the measurement virtual server 294.

In step S15, the measurement unit 115 transmits a measurement packet (described as measurement P in FIG. 5) to the measurement virtual server 292 on the server 272.

In step S16, the measurement virtual server 292 transmits the received measurement packet to the measurement virtual server 293 on the server 273.

In step S17, the measurement virtual server 293 transmits the received measurement packet to the measurement virtual server 294 on the server 274.

In step S18, the measurement virtual server 294 transmits the received measurement packet as a response packet to the performance monitoring device 100.

In step S19, the determination unit 116 determines the presence or absence of a delay of a predetermined value or more. Specifically, the measurement unit 115 measures the transfer time (transfer delay time, second transfer time) by measuring the time from the transmission of the transmission packet in step S15 to the reception of the response packet in step S18. When the transfer time is within a predetermined transfer time defined for the network service provided by the virtual servers 282 to 284, the determination unit 116 determines that there is no delay. When the transfer time (second transfer time) exceeds the predetermined transfer time, the determination unit 116 determines that a delay has occurred (performance is degraded). The determination unit 116 may make a determination by using results of a plurality of measurements instead of making a determination by one measurement. In FIG. 5, the performance monitoring device 100 receives the performance measurement request and performs the measurement only once, but may perform the measurement periodically and repeatedly.

<<Migration Processing>>

FIG. 6 is a sequence diagram of migration processing according to the present embodiment. Processing to be performed by the performance monitoring device 100 when there is a delay (performance degradation) in step S19 in FIG. 5 will be described with reference to FIG. 6.

In step S31, the determination unit 116 instructs the path setting unit 114 to set each of the measurement virtual servers 292 to 294 to transmit the measurement packet to the performance monitoring device 100 instead of transferring the measurement packet along the chain path.

In step S32, the determination unit 116 instructs the measurement unit 115 to transmit the measurement packet to each of the measurement virtual servers 292 to 294.

In step S33, the measurement virtual servers 292 to 294 receive the measurement packet, and then transmit a response packet to the performance monitoring device 100. In step S31, the measurement unit 115 measures a transfer time (first transfer time) from transmission of the measurement packet to reception of the response packet. In FIG. 6, it is described that the measurement unit 115 simultaneously transmits the measurement packet to the measurement virtual servers 292 to 294, but the measurement may be performed by sequentially transmitting the measurement packet.

In step S34, the determination unit 116 determines the presence or absence of a delay. Specifically, the determination unit 116 compares the transfer time (first transfer time) of each of the measurement virtual servers 292 to 294 with the predetermined transfer time of each of the virtual servers 282 to 284, and determines the presence or absence of a delay exceeding the predetermined transfer time for each of the virtual servers 282 to 284. In the description below, it is assumed that the transfer time of the measurement virtual server 293 exceeds a predetermined transfer time (the virtual server 283 is a performance degraded virtual server). Hereinafter, the association unit 117 performs processing of migrating the virtual server 283 from the server 273 currently in operation to another server.

In step S35, the association unit 117 instructs the deployment unit 112 and the path setting unit 114 to perform deployment and path setting of the measurement virtual server 291 to the server 271 different from the server 273. At the time of deployment, deployment is performed so that a resource having the same capacity as that of the virtual server 283 to be subjected to the migration processing is used. Since the measurement virtual server 291 has not been provided until this time point, it is indicated by a dotted frame in FIG. 6. The association unit 117 instructs the path setting unit 114 to set the measurement virtual server 291 to transmit the measurement packet to the performance monitoring device 100 instead of transferring the measurement packet.

In step S36, the association unit 117 instructs the measurement unit 115 to transmit the measurement packet to the measurement virtual server 291.

In step S37, the measurement virtual server 291 receives the measurement packet, and then transmits a response packet to the performance monitoring device 100.

In step S36, the measurement unit 115 measures a transfer time (first transfer time) from transmission of the measurement packet to reception of the response packet.

In step S38, the association unit 117 instructs the determination unit 116 to determine the presence or absence of a delay exceeding a predetermined transfer time of the virtual server 283. Here, the description will be continued assuming that no delay exceeding the predetermined transfer time has occurred. When there is a delay, the measurement virtual server is deployed so as to use another server or another resource. Before step S35, for example, the determination unit 116 may inquire the virtual server management device 560, acquire a server in which no delay occurs, and then instruct the deployment unit 112 to deploy the measurement virtual server to the acquired server.

In step S39, the association unit 117 instructs the server 273 to move the virtual server 283 to the server 271. At the time of the instruction, it is instructed to use the same resource as that of the measurement virtual server 291 after the movement. For example, the association unit 117 may instruct the virtual server management device 560 to move the virtual server 283. Since the virtual server 283 on the server 271 has not operated in the server 271 up to this time point, and thus is indicated by a dotted frame in FIG. 6. Even when the virtual server 283 is moved, the virtual server 282, the virtual server 283, and the virtual server 284, which are the chain paths, do not change.

Steps S41 to S46 are similar to steps S14 to S19 illustrated in FIG. 5. However, the path of the measurement packet is the measurement virtual server 292, the measurement virtual server 291, and the measurement virtual server 294 in this order. When a delay occurs in the network service again, the performance monitoring device 100 repeats the processing from step S31.

<<Features of Performance Monitoring Device>>

The performance monitoring device 100 deploys a measurement virtual server that uses the same resource as that of the virtual server to be monitored. Next, the performance monitoring device 100 measures and monitors the performance of the virtual server by transmitting the measurement packet to the measurement virtual server and measuring a time until a response packet is returned (transfer time, transfer delay time, first transfer time). When the measured transfer time exceeds a predetermined transfer time of the virtual server, the performance monitoring device 100 determines that the virtual server is a performance degraded virtual server.

In the case where the virtual server is a plurality of virtual servers that sequentially performs processing (chains), the performance monitoring device 100 deploys a measurement virtual server using the same resource for each virtual server and performs setting so as to transfer the measurement packet similarly to the path of the virtual server. Further, the performance monitoring device 100 performs monitoring by transmitting the measurement packet to the first measurement virtual server on the path, and measuring the transfer time (second transfer time) until the measurement packet returns from the last measurement virtual server.

When the second transfer time exceeds the predetermined transfer time, the performance monitoring device 100 measures the first transfer time for each virtual server (measurement virtual server) and specifies a virtual server having the transfer time exceeding the predetermined transfer time among the individual virtual servers as a performance degraded virtual server.

The performance monitoring device 100 moves (migrates) the performance degraded virtual server to use another resource in another server or a currently operating server.

By monitoring the performance as described above, it is possible to monitor the performance with higher accuracy as compared with the case of monitoring the performance by monitoring the use state of the CPU or the memory as in the related art. By combining with the technology of measuring a transfer delay time in a network and the technology of specifying a location and a direction of the delay and a delay amount as disclosed in Non Patent Literature 1, it is possible to monitor a transfer delay in a communication path/resource similar to a user traffic consistently with a server and a switch. In addition, it is possible to configure a data center network maintaining a constant transfer delay time. By using the present technology, it is possible to provide a service with the transfer delay time as one index (a numerical value indicating service quality).

<<Modification: Case where Plurality of Virtual Servers Uses Same Resource>>

When a plurality of virtual servers shares the same resource, one measurement virtual server may be deployed instead of deploying the corresponding same number of measurement virtual servers to use the resource.

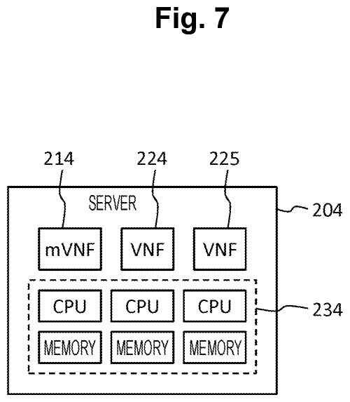

FIG. 7 is a diagram for explaining a relationship related to deployment of virtual servers 224, 225 and a measurement virtual server 214 deployed in a server 204 according to a modification of the present embodiment. Instead of deploying two measurement virtual servers in a resource 234 used by the virtual servers 224,225, one measurement virtual server 214 may be deployed.

<<Other Modifications>>

Although some embodiments of the present invention have been described above, these embodiments are merely examples and do not limit the technical scope of the present invention. The present invention can take various other embodiments, and various modifications such as omissions and substitutions can be made without departing from the gist of the present invention. These embodiments and modifications thereof are included in the scope and gist of the invention described in the present specification and the like, and are included in the invention described in the claims and the equivalent scope thereof.

<<Hardware Configuration>>

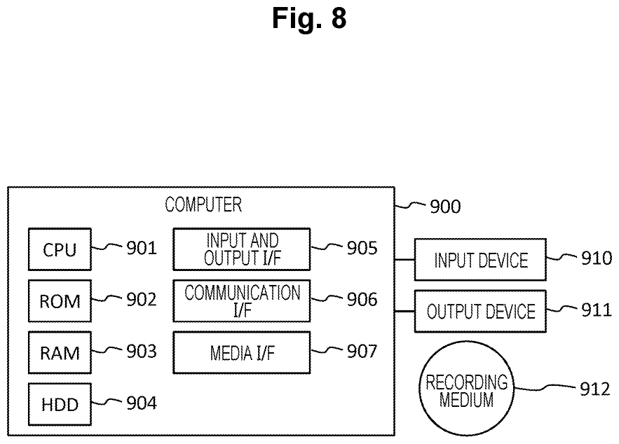

The performance monitoring device 100 according to the present embodiment is achieved by, for example, a computer 900 having a configuration as illustrated in FIG. 8. FIG. 8 is a hardware configuration diagram illustrating an example of a computer 900 that implements functions of the performance monitoring device 100 according to the present embodiment. The computer 900 includes a CPU 901, a read only memory (ROM) 902, a random access memory (RAN) 903, a hard disk 904 (described as a hard disk drive (HDD) in FIG. 8), an input and output interface 905 (described as an input and output interface (I/F) in FIG. 8), a communication interface 906 (described as a communication I/F in FIG. 8), and a media interface 907 (described as a media I/F in FIG. 8).

The CPU 901 operates on the basis of a program stored in the ROM 902 or the hard disk 904, and performs control by the control unit 110 illustrated in FIG. 2. The ROM 902 stores a boot program executed by the CPU 901 when the computer 900 is activated, a program related to hardware of the computer 900, and the like.

The CPU 901 controls the input device 910 such as a mouse and a keyboard and the output device 911 such as a display and a printer via the input and output interface 905. The CPU 901 acquires data from the input device 910 and outputs the generated data to the output device 911 via the input and output interface 905.

The hard disk 904 stores a program executed by the CPU 901, data used by the program, and the like. The communication interface 906 receives data from another device (for example, the virtual server management device 560) not illustrated via a communication network and outputs the data to the CPU 901, and transmits data generated by the CPU 901 to another device via a communication network.

The media interface 907 reads a program or data stored in the recording medium 912 and outputs the program or data to the CPU 901 via the RAM 903. The CPU 901 loads the program from the recording medium 912 onto the RAM 903 via the media interface 907, and executes the loaded program (see the program 131 described in FIG. 2). The recording medium 912 is an optical recording medium such as a digital versatile disk (DVD), a magneto-optical recording medium such as a magneto optical disk (MO), a magnetic recording medium, a conductor memory tape medium, a semiconductor memory, or the like.

For example, when the computer 900 functions as the performance monitoring device 100 according to the present embodiment, the CPU 901 of the computer 900 achieves the function of the performance monitoring device 100 by executing the program 131 (see FIG. 2) loaded on the RAM 903. The CPU 901 reads the program from the recording medium 912 and executes the program. In addition, the CPU 901 may read the program from another device via a communication network, or may install and execute the program 131 from the recording medium 912 to the hard disk 904.

<<Effects>>

Effects of the device will be described below.

A performance monitoring device 100 according to the present embodiment is the performance monitoring device 100 for a virtual server that operates on a physical server (server 200) including a physical resource and provides a network function, the performance monitoring device including: a deployment unit 112 that causes, in a case where the number of the virtual server is one, a measurement virtual server using the same physical resource as the physical resource of the virtual server to operate on the physical server; a path setting unit 114 that sets the measurement virtual server to transmit a response packet to the performance monitoring device 100 for a measurement packet; and a measurement unit 115 that measures a first transfer time from when the measurement packet is transmitted to the measurement virtual server until the response packet is received.

According to such a performance monitoring device 100, it is possible to monitor (measure) the performance of the virtual server with higher accuracy as compared with the case of monitoring the performance by monitoring the use state of the resource (physical resource) such as the CPU or the memory as in the related art. By combining with the technology as disclosed in Non Patent Literature 1, it is possible to monitor a transfer delay in a communication path/resource similar to a user traffic consistently with a server and a switch. In addition, it is possible to configure a data center network maintaining a constant transfer delay time. By using the present technology, it is possible to provide a service with the transfer delay time as one index.

The performance monitoring device 100 according to the present embodiment further includes a path acquisition unit 113, in which, when the virtual server is a plurality of virtual servers that sequentially processes data, the deployment unit 112 causes measurement virtual servers that use the same physical resource as a physical resource of each of the virtual servers to operate on the physical server, the path acquisition unit 113 acquires a path for sequentially processing data of the plurality of virtual servers, the path setting unit 114 sets a measurement virtual server corresponding to a virtual server different from a last virtual server among the measurement virtual servers so that the measurement virtual server sequentially transfers a measurement packet in the same order as an order of the virtual servers of the path, and sets a measurement virtual server corresponding to the last virtual server of the path so that a response packet is transmitted to the performance monitoring device 100 in response to the measurement packet, and the measurement unit 115 measures a second transfer time until the measurement packet is transmitted to the measurement virtual server corresponding to the first virtual server of the path and the response packet is received.

According to such a performance monitoring device 100, it is possible to perform performance monitoring with high accuracy even when a network service is achieved by sequentially processing a plurality of virtual servers.

The performance monitoring device 100 according to the present embodiment further includes a determination unit 116, in which, when the first transfer time is longer than a predetermined time, the determination unit 116 specifies a virtual server using the same physical resource as a physical resource of the measurement virtual server as a performance degraded virtual server, and, when the second transfer time is longer than a second predetermined time, the determination unit 116 measures the first transfer time for each of the plurality of virtual servers to specify the performance degraded virtual server.

According to such a performance monitoring device 100, not only in a case where a network service is achieved by one virtual server, but also in a case where a network service is achieved by a plurality of virtual servers sequentially performing processing, when a delay (performance degradation) exceeding a predetermined time occurs, it is possible to specify which virtual server has a problem (performance degraded virtual server).

The performance monitoring device 100 according to the present embodiment further includes an association unit 117 that moves the performance degraded virtual server to a physical server different from the physical server on which the performance degraded virtual server is operating or to use a physical resource different from the physical resource being used by the performance degraded virtual server.

According to such a performance monitoring device 100, the performance of the performance degraded virtual server can be improved by moving the performance degraded virtual server so as to change the server on which the performance degraded virtual server operates or change the physical resource to be used. In addition, performance of the network service provided by the virtual server is improved.

In the performance monitoring device 100 according to the present embodiment, when the association unit 117 moves the performance degraded virtual server to the physical server as a movement destination, the association unit 117 operates the measurement virtual server using the physical resource having the same capacity as a capacity of the performance degraded virtual server on the physical server, confirms that the first transfer time is shorter than the predetermined time, and then moves the performance degraded virtual server to use the physical source having the same capacity.

According to such a performance monitoring device 100, it is possible to move after confirming the usage status of the physical server/physical resource before moving the performance degraded virtual server, and it is possible to reliably improve the performance of the performance degraded virtual server.

### REFERENCE SIGNS LIST

100 Performance monitoring device
111 Request reception unit
112 Deployment unit
113 Path acquisition unit
114 Path setting unit
115 Measurement unit
116 Determination unit
117 Association unit
131 Program
200, 201, 204, 205 to 207, 271 to 274 Server
211, 212, 214, 251 to 254, 291 to 294 Measurement virtual server
221, 222, 224, 225, 261 to 264, 282 to 284 Virtual server
231 to 232, 234, 236 to 239 Resource (physical resource)
300 Switch
560 Virtual server management device

1. A performance monitoring device for a virtual server that operates on a physical server including a physical resource and provides a network function, the performance monitoring device comprising a processor configured to perform operations comprising:
causing, in a case where a number of the virtual server is one, a measurement virtual server using a same physical resource as the physical resource of the virtual server to operate on the physical server;
setting the measurement virtual server to transmit a response packet to the performance monitoring device for a measurement packet; and
measuring a first transfer time from when the measurement packet is transmitted to the measurement virtual server until the response packet is received.

2. The performance monitoring device according to claim 1, the operations further comprising:
when the virtual server is a plurality of virtual servers that sequentially processes data, causing measurement virtual servers that use the same physical resource as a physical resource of each of the virtual servers to operate on the physical server,
acquiring a path for sequentially processing the data of the plurality of virtual servers;
setting a measurement virtual server corresponding to a virtual server different from a last virtual server among the measurement virtual servers so that the measurement virtual server sequentially transfers a measurement packet in the same order as an order of the virtual servers of the path, and sets a measurement virtual server corresponding to the last virtual server of the path so that a response packet is transmitted to the performance monitoring device in response to the measurement packet; and
measuring a second transfer time from when the measurement packet is transmitted to a measurement virtual server corresponding to the first virtual server of the path until the response packet is received.

3. The performance monitoring device according to claim 2, the operations further comprising:
when the first transfer time is longer than a predetermined time, specifying a virtual server using the same physical resource as a physical resource of the measurement virtual server as a performance degraded virtual server, and;
when the second transfer time is longer than a second predetermined time, measuring the first transfer time for each of the plurality of virtual servers to specify the performance degraded virtual server.

4. The performance monitoring device according to claim 3, the operations further comprising:
moving the performance degraded virtual server to a physical server different from a physical server on which the performance degraded virtual server is operating or to use a physical resource different from a physical resource being used by the performance degraded virtual server.

5. The performance monitoring device according to claim 4,
wherein, when the processor moves the performance degraded virtual server to the physical server as a movement destination, the processor operates a measurement virtual server using a physical resource having the same capacity as a capacity of the performance degraded virtual server on the physical server, confirms that the first transfer time is shorter than the predetermined time, and then moves the performance degraded virtual server to use the physical source having the same capacity.

6. (canceled)

7. A performance monitoring method of a performance monitoring device for a virtual server that operates on a physical server including a physical resource and provides a network function, the performance monitoring method comprising:
causing, in a case where a number of the virtual server is one, a measurement virtual server using a same physical resource as the physical resource of the virtual server to operate on the physical server;
setting the measurement virtual server to transmit a response packet to the performance monitoring device for a measurement packet; and
measuring a first transfer time from when the measurement packet is transmitted to the measurement virtual server until the response packet is received.

8. A non-transitory computer-readable medium storing program instructions that, when executed by a processor, cause a performance monitoring device to perform operations comprising:
causing, in a case where a number of a virtual server is one, a measurement virtual server using a same physical resource as the physical resource of the virtual server to operate on a physical server;
setting the measurement virtual server to transmit a response packet to the performance monitoring device for a measurement packet; and
measuring a first transfer time from when the measurement packet is transmitted to the measurement virtual server until the response packet is received.
